(19) United States
(12) Patent Application Publication
(10) Pub. No.: US 2026/0252502 A1
(43) Pub. Date: Aug. 27, 2026

(54) SYSTEMS AND METHODS FOR COHERENCE MANAGEMENT FOR A VIRTUAL POOL OF MEMORY (VPOM)

(71) Applicant: Samsung Electronics Co., Ltd., Suwon-si (KR)

(72) Inventors: Yang Seok Ki, Palo Alto, CA (US); Myung June Jung, Santa Clara, CA (US)

(21) Appl. No.: 19/308,162

(22) Filed: Aug. 22, 2025

Related U.S. Application Data
(60) Provisional application No. 63/763,004, filed on Feb. 25, 2025.

(51) Int. Cl. G06F 13/16; G06F 11/34

(52) U.S. Cl. CPC G06F 13/1663; G06F 11/3419; G06F 13/1621

(57) ABSTRACT

Provided are systems and methods for memory management. A method includes receiving, by an access processing circuit associated with a first shared memory of a first host, a first transaction request, the first transaction request including a request to access first data from the first shared memory, and including first coherence information having a first status, the first coherence information indicating a request to receive a first data-change notification, receiving, by the access processing circuit, a second transaction request to access the first data from the first shared memory, the second transaction request causing a first data change of the first data, and based on determining that the first coherence information has a second status that is different from the first status, modifying a first entry including the first coherence information.

### CROSS-REFERENCE TO RELATED APPLICATION(S)

This application claims priority to, and benefit of, U.S. Provisional Application Ser. No. 63/763,004, filed on Feb. 25, 2025, entitled “COHERENCE MANAGEMENT FOR VIRTUAL POOL OF MEMORY (VPOM) SYSTEMS,” the entire content of which is incorporated herein by reference.

### FIELD

One or more aspects of embodiments according to the present disclosure relate to computing systems, and more particularly to systems and methods for coherence management for a virtual pool of memory (VPoM).

### BACKGROUND

In the field of computers, a computing system may include one or more hosts and one or more memory devices connected to (e.g., communicatively coupled to) the one or more hosts. Such computing systems have become increasingly popular, in part, for allowing many different users to share the computing resources of the system. Memory requirements have increased over time as the number of users of such systems and the number and complexity of applications running on such systems have increased.

The present background section is intended to provide context only, and the disclosure of any embodiment or concept in this section does not constitute an admission that said embodiment or concept is prior art.

### SUMMARY

Aspects of some embodiments of the present disclosure are directed to computing systems for improved data access management.

According to some embodiments of the present disclosure, there is provided a method for memory management, the method including receiving, by an access processing circuit associated with a first shared memory of a first host, a first transaction request, the first transaction request including a request to access first data from the first shared memory, and including first coherence information having a first status, the first coherence information indicating a request to receive a first data-change notification, receiving, by the access processing circuit, a second transaction request to access the first data from the first shared memory, the second transaction request causing a first data change of the first data, and based on determining that the first coherence information has a second status that is different from the first status, modifying a first entry including the first coherence information.

The method may further include receiving, by the access processing circuit, a third transaction request causing a second data change of second data of the first shared memory, and based on determining that second coherence information has the first status, sending a second data-change notification.

The modifying the first entry may include making a memory space, including data associated with the request to receive the first data-change notification, available.

The first coherence information may include a first portion indicating the request to receive the first data-change notification and a second portion representing a limit on the request to receive the first data-change notification, and the second status indicates that the limit is exceeded.

The first transaction request may include a header, the header including the first coherence information and source identifying information, the source identifying information indicating the source of the first transaction request.

The access processing circuit may determine that the first data-change notification is to be sent outside of the first host based on the first coherence information, and the method may further include adding the first entry, the first entry including the first coherence information.

The method may further include searching, by the access processing circuit, a coherence table for a second entry having the second status, and modifying the second entry in the coherence table.

According to some other embodiments of the present disclosure, there is provided a system for memory management, the system including a processing circuit, and a memory storing instructions, which, based on being executed by the processing circuit, cause the processing circuit to perform receiving a first transaction request including a request to access first data from a first shared memory, and including first coherence information having a first status, the first coherence information indicating a request to receive a first data-change notification, receiving a second transaction request to access the first data from the first shared memory, the second transaction request causing a first data change of the first data, and based on determining that the first coherence information has a second status that is different from the first status, modifying a first entry including the first coherence information.

The instructions, based on being executed by the processing circuit, may cause the processing circuit to perform receiving a third transaction request causing a second data change of second data of the first shared memory, and based on determining that second coherence information has the first status, sending a second data-change notification.

The modifying the first entry may include making a memory space, including data associated with the request to receive the first data-change notification, available.

The first coherence information may include a first portion indicating the request to receive the first data-change notification and a second portion representing a limit on the request to receive the first data-change notification, and the second status indicates that the limit is exceeded.

The first transaction request may include a header, the header including the first coherence information and source identifying information, the source identifying information indicating the source of the first transaction request.

The instructions, based on being executed by the processing circuit, may cause the processing circuit to perform determining that the first data-change notification is to be sent outside of the first host based on the first coherence information, and adding the first entry, the first entry including the first coherence information.

The instructions, based on being executed by the processing circuit, may cause the processing circuit to perform searching a coherence table for a second entry having the second status, and modifying the second entry in the coherence table.

According to some other embodiments of the present disclosure, there is provided a system for memory management, the system including an access processing circuit associated with a first shared memory, wherein the access processing circuit is configured to perform receiving a first transaction request including a request to access first data from the first shared memory, and including first coherence information having a first status, the first coherence information indicating a request to receive a first data-change notification, receiving a second transaction request to access the first data from the first shared memory, the second transaction request causing a first data change of the first data, and based on determining that the first coherence information has a second status that is different from the first status, modifying a first entry including the first coherence information.

The access processing circuit may be configured to perform receiving a third transaction request causing a second data change of second data of the first shared memory, and based on determining that second coherence information has the first status, sending a second data-change notification.

The modifying the first entry may include making a memory space, including data associated with the request to receive the first data-change notification, available.

The first coherence information may include a first portion indicating the request to receive the first data-change notification and a second portion representing a limit on the request to receive the first data-change notification, and the second status may indicate that the limit is exceeded.

The first transaction request may include a header, the header including the first coherence information and source identifying information, the source identifying information indicating a source of the first transaction request.

The access processing circuit may be configured to perform searching a coherence table for a second entry having the second status, and modifying the second entry in the coherence table.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1A is a block diagram depicting a system for providing a memory pool (e.g., a VPoM), according to some embodiments of the present disclosure.

FIG. 1B is a block diagram depicting components of a memory device in the system of FIG. 1A, according to some embodiments of the present disclosure.

FIG. 2 is a block diagram depicting components of an access gateway of the memory device depicted in FIG. 1B, according to some embodiments of the present disclosure.

FIG. 3A is a block diagram depicting features of a memory transaction request packet for accessing data in a VPoM instance, the VPoM instance being created from donated memory regions (DMRs) of the system of FIG. 1A, according to some embodiments of the present disclosure.

FIG. 3B is a diagram depicting coherence tables for coherence management for the VPoM instance created from DMRs of the system of FIG. 1A, according to some embodiments of the present disclosure.

FIG. 4 is a diagram depicting a method for performing a VPoM coherence management operation when there is a VPoM memory read request, according to some embodiments of the present disclosure.

FIG. 5 is a diagram depicting a method for performing a VPoM coherence management operation when there is a VPoM memory write request, according to some embodiments of the present disclosure.

FIG. 6 is a diagram depicting a method for performing a VPoM coherence management operation for implementing a periodic housekeeping task loop, according to some embodiments of the present disclosure.

FIG. 7 is a diagram depicting a method for memory management for a VPoM, according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression “A and/or B” denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Any of the functionalities described herein, including any of the functionalities that may be implemented with a host, a device, and/or the like or a combination thereof, may be implemented with hardware, software, firmware, or any combination thereof including, for example, hardware and/or software combinational logic, sequential logic, timers, counters, registers, state machines, volatile memories such as dynamic RAM (DRAM) and/or static RAM (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application-specific ICs (ASICs), central processing units (CPUs) including complex instruction set computer (CISC) processors and/or reduced instruction set computer (RISC) processors, graphics processing units (GPUs), neural processing units (NPUs), tensor processing units (TPUs), data processing units (DPUs), and/or the like, executing instructions stored in any type of memory. In some embodiments, one or more components may be implemented as a system-on-a-chip (SoC).

Any of the computational devices disclosed herein may be implemented in any form factor, such as 3.5 inch, 2.5 inch, 1.8 inch, M.2, Enterprise and Data Center Standard Form Factor (EDSFF), NF1, and/or the like, using any connector configuration such as Serial Advanced Technology Attachment (SATA), Small Computer System Interface (SCSI), Serial Attached SCSI (SAS), U.2, and/or the like. Any of the computational devices disclosed herein may be implemented entirely or partially with, and/or used in connection with, a server chassis, server rack, data room, data center, edge data center, mobile edge data center, and/or any combinations thereof.

Any of the devices disclosed herein that may be implemented as storage devices may be implemented with any type of nonvolatile storage media based on solid-state media, magnetic media, optical media, and/or the like. For example, in some embodiments, a storage device (e.g., a computational storage device) may be implemented as an SSD based on not-AND (NAND) flash memory, persistent memory such as cross-gridded nonvolatile memory, memory with bulk resistance change, PCM, and/or the like, or any combination thereof.

Any of the communication connections and/or communication interfaces disclosed herein may be implemented with one or more interconnects, one or more networks, a network of networks (e.g., the Internet), and/or the like, or a combination thereof, using any type of interface and/or protocol. Examples include Peripheral Component Interconnect Express (PCIe), non-volatile memory express (NVMe), NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, SATA, SCSI, SAS, Internet Wide Area RDMA Protocol (iWARP), and/or a coherent protocol, such as Compute Express Link (CXL), CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced eXtensible Interface (AXI), any generation of wireless network including 2G, 3G, 4G, 5G, 6G, and/or the like, any generation of Wi-Fi, Bluetooth, near-field communication (NFC), and/or the like, or any combination thereof.

In some embodiments, a software stack may include a communication layer that may implement one or more communication interfaces, protocols, and/or the like such as PCIe, NVMe, CXL, Ethernet, NVMe-oF, TCP/IP, and/or the like, to enable a host and/or an application running on the host to communicate with a computational device or a storage device.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits, for example, a processing circuit may include two processing circuits, an FPGA and a CPU, interconnected on a PCB.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of computers, a computing system may include one or more hosts and one or more memory devices connected to (e.g., communicatively coupled to) the one or more hosts. For example, a data center may perform data access management to provide computing resources of one or more hosts and/or one or more memory devices to users. The computing resources may be provided based on a plurality of interconnected nodes (e.g., any device that can initiate memory access, such as hosts and/or memory devices) in the computing systems. Such systems may be used in large-scale high-performance computing systems, including inferencing systems and/or training systems for large language models, and/or mixture of expert systems.

In some systems, an approach that utilizes only locally attached memory per memory pool may create siloed memories, which may cause a stranded memory problem in which memory is underutilized and/or not enough memory can be utilized to provide a suitable memory pool. In some systems, an approach that utilizes disaggregated memory per memory pool may result in long latencies to access pooled memory. In some systems, performance bottlenecks may occur, in part, due to nodes (e.g., hosts) sending data-change notifications to every node in the system, when data on a given node is changed, to allow for memory coherence across the system.

Aspects of some embodiments of the present disclosure provide for systems and methods with improved performance (e.g., improved data access) and improved data coherence based on enabling memory pools (e.g., VPoMs) to be built with donated memory (e.g., DMRs) by including an access gateway, a local memory manager, and one or more interconnect-protocol ports (e.g., CXL ports) in locally attached (e.g., extendable) memory modules (e.g., in locally attached CXL memory modules (CMMs)) and by utilizing a global manager to coordinate the building of memory pools and to coordinate the testing (e.g., testing at a training stage of memory-pool creation) of the memory pools. As used herein, an “interconnect protocol” refers to a protocol for interconnecting multiple nodes (e.g., hosts and memory devices) together for communicating data packets and control information between the nodes. For example, CXL may be one example of an interconnect protocol. In some embodiments, the interconnect protocol (e.g., CXL) provides options to control (e.g., the interconnect protocol enables control of) cache coherence among nodes. In some embodiments, one or more of the nodes may include (e.g., may be) a CPU, an accelerator (such as a GPU, an NPU, an FPGA, and/or the like), memory devices, and/or the like.

Aspects of some embodiments of the present disclosure provide systems and methods for coherence management in a VPoM to help scale out the VPoM system while reducing (e.g., minimizing) the overhead of transaction monitoring and signaling for coherence management. Aspects of some embodiments of the present disclosure provide for coherence management components utilizing a coherence table (e.g., a coherence-control table) as a data structure to reduce transaction monitoring and signaling for improved performance and data coherence in a VPoM system.

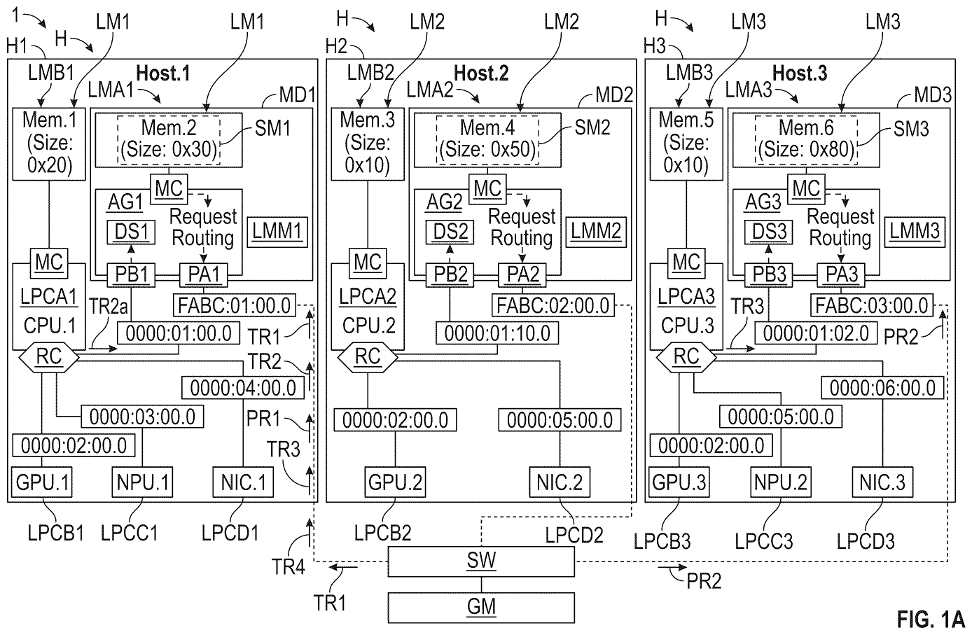

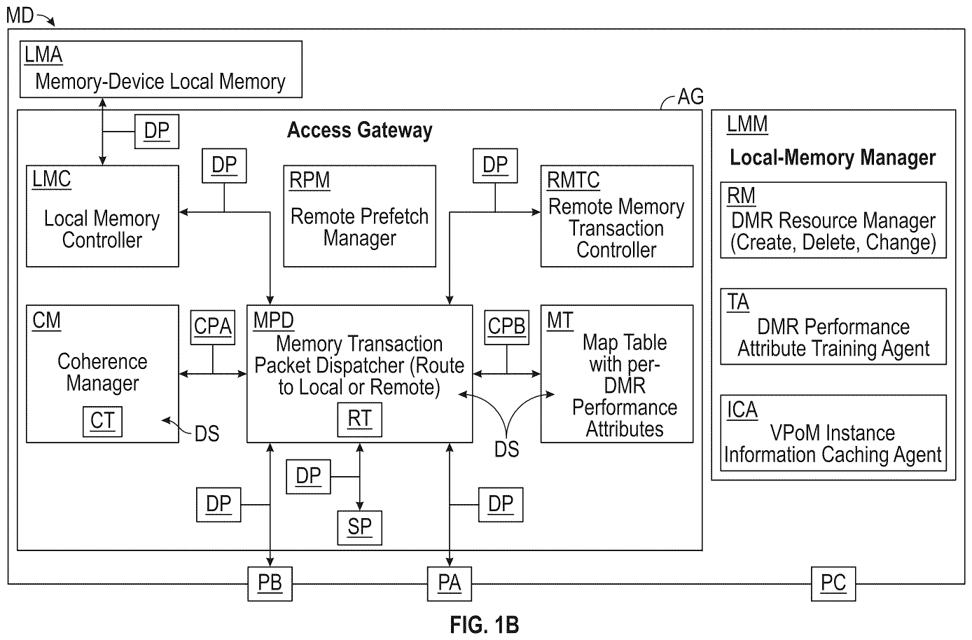

FIG. 1A is a block diagram depicting a system for providing a memory pool, according to some embodiments of the present disclosure.

Referring to FIG. 1A, the system 1 may include one or more hosts H (e.g., hosts H1, H2, and H3). As used herein, the figures (e.g., FIGS. 1A to 3A) include reference names including one or more letters followed by a specific number. In such cases, the numbers are intended to distinguish between specific instances of a given type of element depicted in the figures. The present disclosure refers to a given type of element without a specific number to describe that type of element generally. For example, the host H could refer to any given host, while the host H1 (or the first host H1) refers to a specific host depicted in the figures. The system 1 may include a global manager GM communicatively connected to the hosts H. In some embodiments, the global manager GM may be connected to the hosts via a switch SW (e.g., an interconnect switch, such as a CXL switch). In some embodiments, the global manager GM may be a component of one or more hosts. For example, the global manager GM may be a sub-component of one host, or may be one host itself, or may exist in multiple hosts (e.g., working in a distributed and cooperative way to avoid a single point of failure).

In some embodiments, each host H may include a local memory LM (e.g., a first local memory LM1, a second local memory LM2, or a third local memory LM3) that is local to a given host H. The local memory LM may include a memory-device local memory LMA (e.g., a shareable portion of the local memory LM) and may include a reserved local memory LMB (e.g., a non-shareable portion of the local memory LM). For example, the memory-device local memory LMA may be available for creating one or more memory pools (also referred to as memory groups) with, or without, other memory-device local memories LMA of other hosts H. The reserved local memory LMB may be reserved for use by only the local host H. For example, a first reserved local memory LMB1 may be reserved for use by only the first host H1. The memory-device local memory LMA may be partitioned to generate one or more shared memories (e.g., a first shared memory SM1). The first shared memory SM1 may also be referred to as a first donated memory region (e.g., DMR1). The shared memory SM may be accessible to data operations associated with transaction requests TR from one or more sources external to the local host H (e.g., transaction requests TR originating from outside the local host H). For example, the first shared memory SM1 may be accessible to a data operation associated with a first transaction request TR1 originating from the second host H2 or from the third host H3.

As used herein, a “memory pool” (also referred to as a memory group) refers to memory that that is made accessible to one or more nodes and may be built (e.g., created) using portions of memory associated with one or more different nodes. For example, a memory pool may be a resource pool (e.g., a pool of memory resources), which can provide any suitable combination of selected resources from among a set of resources (e.g., from among a full set of resources).

In some embodiments, the memory-device local memory LMA may be associated with (e.g., may correspond to) a given memory device MD. For example, a first memory-device local memory LMA1 may be associated with a first memory device MD1 on the first host H1. The memory device MD may be associated with (e.g., may include) an access gateway AG (e.g., a local-memory-access processing circuit, also referred to as an access processing circuit) and associated with a local memory manager LMM. For example, a first memory device MD1 may be associated with a first access gateway AG1 and with a first local memory manager LMM1. The memory device MD may be associated with a first port PA (e.g., a first port associated with an in-band channel) and with a second port PB (e.g., a second port associated with the in-band channel). In some embodiments, the first port PA may handle communications (e.g., transaction requests and/or participation requests PR) from the other hosts H, the global manger GM, and/or the switch SW. In some embodiments, the second port PB may handle communications (e.g., transaction requests) from one or more local processing circuits LPC (e.g., a first local processing circuit LPCA, a second local processing circuit LPCB, a third local processing circuit LPCC, a fourth local processing circuit LPCD, etc.). The local processing circuits LPC may include one or more of a CPU, a GPU, an NPU, a network interface card (NIC), and/or the like. In some embodiments, one or more local processing circuits LPC may receive and/or transmit messages (e.g., transaction requests TR) via a root complex RC (associated with PCIe/CXL) and may communicate with the reserved local memory LMB via a memory controller MC. In some embodiments, the root complex RC is located (e.g., connected) between CPU and PCIe/CXL fabrics. The root complex RC may connect to PCIe/CXL endpoints (such as GPUs, NICs, SSDs) via PCIe/CXL switches or direct links.

In some embodiments, the access gateway AG may utilize one or more data structures DS to perform one or more functions, including: data routing (e.g., local packet routing and/or remote packet routing), coherence management, data prefetching, and/or stream processing to enhance the performance of memory transactions.

In some embodiments, a given local-memory manager LMM may manage a corresponding shared memory SM on the same given host H. For example, a first local memory manager LMM1 may manage the first shared memory SM1 on the first host H1. In some embodiments, the local-memory manager LMM may partition a corresponding local memory LM to create and to donate memory regions (DMRs) (e.g., shared memories SM) to build one or more VPoM instances. In some embodiments, the local-memory manager LMM may test for (e.g., may train) performance attributes of the shared memories SM (e.g., of the remote shared memories SM). For example, the first local-memory manager LMM1 may test for one or more performance attributes such as latency, bandwidth, capacity, throughput, and/or the like based on transaction requests TR originating from the second host H2 and/or the third host H3. In some embodiments, the local-memory manager LMM may generate and/or collect shared-memory information indicating one or more performance attributes of one or more shared memories SM for storing in a given data structure DS and/or transmitting to the global manager GM in coordinating the building of a given memory pool.

In some embodiments, the global manager GM may coordinate the building of memory-pool instances in the system 1. In some embodiments, the global manager GM may coordinate the testing of (e.g., the training of) performance attributes of the memory-pool instances in the system 1. The global manager GM may serve as a global coordinator for VPoM instance creation and other management activities (e.g., other management operations).

As an example of some of the operations of system 1, and still referring to FIG. 1A, the global manager GM may determine to create a memory pool to meet given performance attributes (e.g., to meet given latency, bandwidth, throughput, and/or capacity attributes). The global manager GM may send participation requests PR to one or more of the hosts H1 to H3. For example, the global manager GM may send a first participation request PR1 to the first host H1 and may send a second participation request PR2 to the third host H3.

The first access gateway AG1 may receive the first participation request PR1 and a third access gateway AG3 may receive the second participation request PR2. The participation requests PR may include information for determining whether memory resources qualify to meet the performance attributes for the memory pool. The first local-memory manager LMM1 may determine that memory resources of the first memory-device local memory LMA1 may be used to meet the performance attributes and may partition the first memory-device local memory LMA1 into the first shared memory SM1 and donate the first shared memory SM1 to the memory pool. Likewise, a third local-memory manager LMM3 may partition a third memory-device local memory LMA3 into a third shared memory SM3 and donate the third shared memory SM3 to the memory pool. Accordingly, the global manger GM may coordinate with the local-memory mangers LMM to create a pool of memory composed of shared memories SM from different hosts H (e.g., from different memory devices MD of the different hosts H).

In some embodiments, the global manager GM and the local-memory managers LMM may coordinate to test for the performance attributes of the shared memories SM. For example, the local memory managers LMM may send shared-memory information indicating one or more performance attributes of their respective shared memories to the global manager GM. In some embodiments, the global manager GM may coordinate the testing of performance attributes. For example, the global manager GM may coordinate a sending of test transaction requests TR between the hosts in order to determine latencies associated with the test transaction requests TR.

In some embodiments, access gateways AG may perform routing of transaction requests and/or participation requests. In some embodiments, the access gateways AG may utilize one or more data structures DS to perform a variety of functions associated with the transaction requests (e.g., functions such as routing memory requests, managing coherence, managing prefetch requests, and performing stream processing operations). For example, the first access gateway AG1 may receive the first transaction request TR1, which originated from outside of the first host H1. The first access gateway AG1 may refer to the first data structure DS1 to determine whether the first transaction request TR1 should be forwarded (e.g., re-routed) to a different host H (e.g., the second host H2 or the third host H3) or processed by the first shared memory SM1. For example, the first access gateway AG1 may route the first transaction request TR1 to the first shared memory SM1. The routing of the first transaction request TR1 to the first shared memory SM1 may cause a data operation (e.g., a read operation or a write operation) associated with the first transaction request TR1 to be performed on the first shared memory SM1.

In some embodiments, the access gateway AG may add records (e.g., entries) to one or more data structures DS for performing coherence managing, data prefetching, and/or stream processing to enhance the performance of memory transactions.

Still referring to FIG. 1A, each host H may have its local memory LM (e.g., ‘Mem.1’ in the case of ‘Host.1’). For example, Mem.1 may correspond to the first reserved local memory LMB1. In some embodiments, the first reserved local memory LMB1 may be equipped on local dual in-line memory-module (DIMM) slots. Each host H may also have at least one memory device MD (e.g., at least one CXL Memory Module for VPoM (CMM-VPoM)). In some embodiments, the memory device MD may have a local memory manager LMM (e.g., a VPoM Local Manager (VPoM.LM)), an access gateway AG (e.g., a Virtual Pool Access Gateway (VPAG)), memory-device local memory LMA (e.g., ‘Mem.2’ in the case of ‘Host.1’), and (at least) two ports (e.g., CXL ports) (e.g., PA and PB). In some embodiments, one of the two ports of memory device MD is connected to the local host, and the other port is connected to the switch SW (e.g., the CXL switch).

In some embodiments, the local-memory manger LMM (e.g., VPoM.LM) manages the partition and donation of the memory-device local memory LMA (e.g., CMM-VPoM local memory) (‘Mem.2’ in case of ‘Host.1’). The local-memory manager LMM may create, delete, and/or change the partition of memory-device local memory LMA based on an administrator's configuration information or based on a predefined master default configuration (e.g., “50% of capacity (lower half of CMM-VPoM local memory's address range) will be used for local host use, 50% of capacity (higher half (e.g., upper half) of CMM-VPoM local memory's address range) will be donated for VPoM”). In some embodiments, the local-memory manager LMM (e.g., VPoM.LM) can determine (e.g., can decide) one or more partitions of the memory device MD (e.g., CMM-VPoM local memory) to be donated for a VPoM instance. A donated CMM-VPoM memory partition may be referred to as a DMR. A VPoM instance can be viewed as a virtual set of DMRs from participating memory devices MD (e.g., participating CMM-VPoMs). The local-memory manager LMM (e.g., VPoM.LM) may interact with the global manager GM (e.g., VPoM.GM) to provide information related to the DMR, so that the global manager GM (e.g., VPoM.GM) can create, delete, and/or change the VPoM instance based on the information. In some embodiments, the local-memory manager LMM (e.g., VPoM.LM) collects DMR performance attribute information during the VPoM instance testing (e.g., training phase), as directed by the global manager GM (e.g., VPoM.GM).

In some embodiments, the access gateway AG (e.g., VPAG) performs a variety of roles in VPoM systems. Firstly, the access gateway AG (e.g., VPAG) may perform a memory access gateway role. Based on the target memory address of a memory transaction packet (e.g., a CXL memory transaction packet), the access gateway AG (e.g., VPAG) may forward the memory transaction packet to the memory-device local memory LMA (e.g., ‘Mem.2’ in case of ‘Host.1’), or may forward it to the remote memory (e.g., ‘Mem.4’ or ‘Mem.6’, also referred to respectively as LMA2 and LMA3). In some embodiments, the access gateway AG (e.g., VPAG) processes the transaction requests TR (e.g., CXL memory read or write requests) received from the access gateways AGs (e.g., VPAGs) of other hosts H. Secondly, VPAG may perform a DMR performance attribute information provider role. For example, an access gateway AG (e.g., VPAG) may provide an operating system (OS) of a host H with the expected (e.g., trained) latency and bandwidth information of each local or remote memory module that constitutes a VPoM instance, so that the OS can use the VPoM instance properly considering performance characteristics of the memory devices MD. To perform these two roles, the access gateway AG (e.g., VPAG) may construct and maintain one or more data structures DS, including a memory request/response routing table (MRRT), and a memory proximity domain table (MPDT).

Thirdly, and as discussed in further detail below, the access gateway AG (e.g., VPAG) may perform a coherence-management role utilizing a coherence manager CM and the data structure DS. For example, the data structure DS may include a coherence table CT (also referred to as a coherence management table, or a coherence control table) (see FIG. 1B).

In some embodiments, the global manager GM (e.g., VPoM.GM) may coordinate one or more (e.g., all) of the VPoM-instance related management actions. These management actions may include creating, deleting, and/or changing VPoM instances, directing local memory managers LMMs (e.g., VPoM.LM) to perform DMR performance attribute training, configuring the switch SW (e.g., the CXL switch) for packet forwarding based on the memory address ranges and corresponding device map, and monitoring the health (e.g., the health status) of VPoM instances.

As an overview of component details, the system 1 for providing a memory pool (e.g., a VPoM) may include the global manager GM and the memory device MD. The memory device MD may include an access gateway AG and a local memory manager LMM.

The access gateway AG may be characterized by having: (1) a memory transaction packet dispatcher MPD (see FIG. 1B), (2) a map table MT (e.g., a VPoM address map table) with per-DMR performance attributes, (3) a remote memory transaction controller RMTC, (4) a local memory controller LMC, (5) a coherence manager CM (e.g., a VPoM coherency manager), (6) a remote prefetch manager RPM (e.g., a remote memory data prefetch manager), and (7) a stream processor SP (e.g., a VPoM stream processor).

The local memory manager LMM may be characterized by having: (1) a DMR resource manager RM (see FIG. 1B) to create, delete, and/or change VPoM instances, (2) a DMR performance attribute training agent TA, and (3) a VPoM instance information caching agent ICA.

The global manager GM may be characterized by having: (1) a VPoM instance manager to create, delete, and/or change VPoM instances, (2) a DMR performance attribute training coordinator TC to assist in coordinating the testing of performance attributes of DMRs, and (3) a VPoM instance information server to communicate with the local-memory managers LMM to provide VPoM instance access information to each host H.

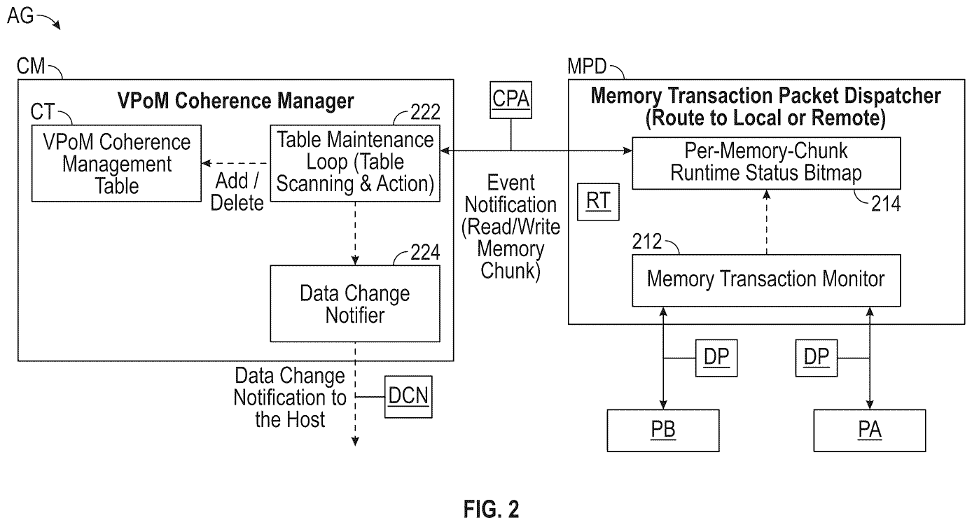

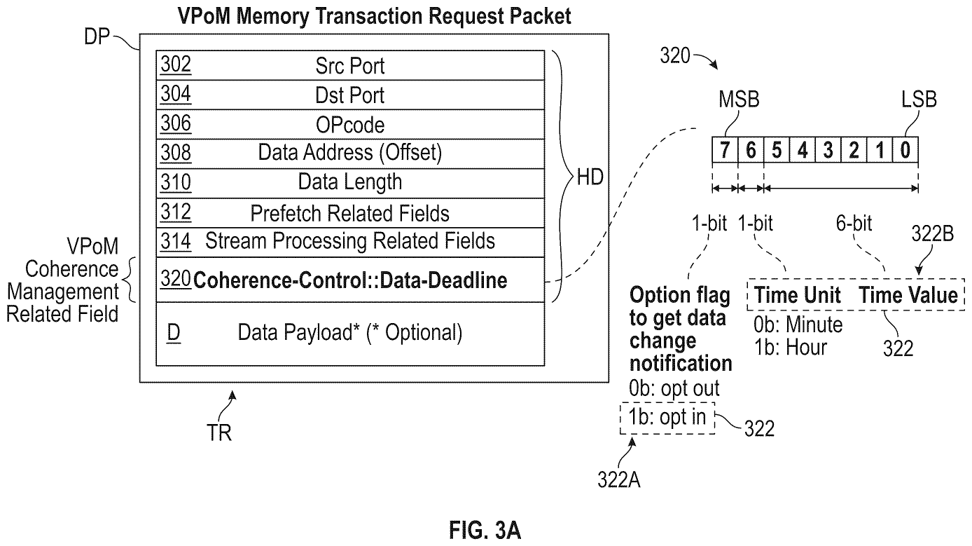

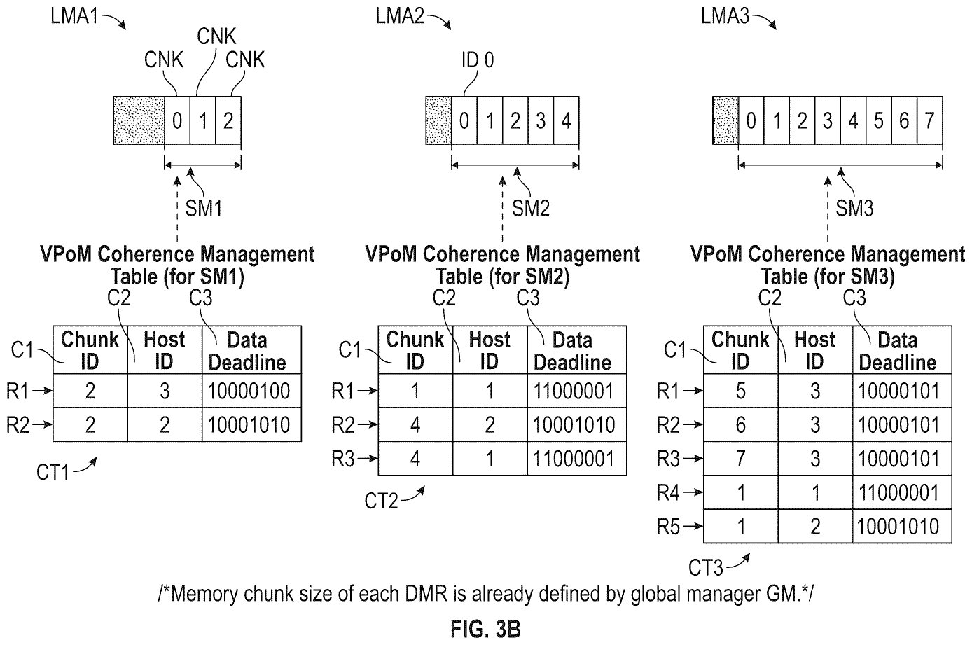

Still referring to FIG. 1A, and as an example overview of a coherence-management scheme of the system 1, the first access gateway AG1 of the first host H1 may use the first data structure DS1 to manage data coherence. For example, the second host H2 may send the first transaction request TR1 to the first host H1 to access first data on the first shared memory SM1. For example, the first transaction request TR1 may include a request to access the first data on the first shared memory SM1. The first transaction request TR1 (e.g., a memory transaction request) may be associated with a read operation or a write operation. The first transaction request TR1 may include a data packet DP (see FIG. 3A) including coherence information 320 (e.g., coherence-control information). The coherence information 320 may indicate that the second host H2 is interested in receiving (e.g., has requested) data-change notifications DCN (see FIG. 2). For example, the coherence information 320 may indicate a request to receive a data-change notification DCN. The data-change notification DCN may be sent from the first host H1 to the second host H2 based on the first data changing. In some embodiments, the first access gateway AG1 may store the coherence information 320 for the first transaction request TR1 in the first data structure DS1 (e.g., in the coherence table CT of the first data structure DS1 (see FIG. 1B)). The coherence information 320 may have a first status 322 (e.g., an opt-in status 322A indicating opted in and an interest limit 322B indicating interested (see FIG. 3A)). The first status 322 may indicate that the second host H2 has requested to receive data-change notifications DCN if a data-change event changes the first data and if the second host H2 is still interested (e.g., if a data-deadline time indicated by the second host H2 has not expired).

The first gateway AG1 may receive a second transaction request TR2 from the third host H3 after receiving the first transaction request TR1. The second transaction request TR2 may cause the first data of the first shared memory SM1 to change. For example, the second transaction request TR2 may cause (e.g., may trigger) one or more other components of the system 1 to change the first data of the first shared memory SM1. In some embodiments, the second transaction request TR2 may directly change the first data of the first shared memory SM1. That is, the second transaction request TR2 may be a request causing a data change (e.g., a first data change) of the first data.

The first access gateway AG1 may scan the coherence table CT (e.g., a coherence-control table), based on the data-change event occurring in the first data of the first shared memory SM1, to determine if the first status 322 indicates that the second host H2 is still interested in receiving data-change notifications DCN regarding the first data. For example, the first access gateway AG1 may determine whether the interest limit 322B indicates that a data deadline has expired (e.g., by comparing the data deadline with a period of time that has passed since the first transaction request TR1 was received). The first access gateway AG1 may determine that the coherence information 320 has a second status 322 (e.g., an opt-in status 322A indicating opted in and an interest limit 322B indicating not interested (no longer interested, limit exceeded, or interest expired)). Based on the second status 322 indicating not interested (or limit exceeded), the first access gateway AG1 may determine not to send the data-change notification DCN, even though a data-change event has occurred in the first data. The first access gateway AG1 may modify (e.g., clear or delete) an entry in the coherence table CT that includes the coherence information 320 associated with the first transaction request TR1, such that a corresponding memory space associated with the entry is made available.

The first access gateway AG1 may receive a third transaction request TR3 from the second host H2 to access the first data on the first shared memory SM1. The coherence information 320 of the third transaction request TR3 may have the first status 322 indicating that the second host H2 has requested data-change notifications DCN (e.g., has opt-in status 322A indicating opted in) during a specified interest limit 322B (e.g., for one hour) regarding changes to the first data in the first shared memory SM1. The first access gateway AG1 may receive a fourth transaction request TR4 from the third host H3 to access the first data on the first shared memory SM1. The fourth transaction request TR4 may cause the first data to change (e.g., after the time the third transaction request TR3 was received).

The first access gateway AG1 may scan the coherence table CT (e.g., a coherence-control table), based on the data-change event occurring in the first data of the first shared memory SM1 (as a result of the fourth transaction request TR4), to determine if the coherence information 320 indicates that the second host H2 is still interested in receiving data-change notifications DCN regarding the first data. For example, the first access gateway AG1 may determine whether the interest limit 322B indicates that a data deadline has expired (e.g., by comparing the data deadline with a period of time that has passed since the third transaction request TR3 was received). The first access gateway AG1 may determine that the coherence information 320 has the first status 322 (e.g., an opt-in status 322A indicating opted in and an interest limit 322B indicating interested (e.g., not expired or the one-hour time period has not yet passed)). Based on the first status 322 indicating interested, the first access gateway AG1 may determine to send the data-change notification DCN to the second host H2. The first access gateway AG1 may maintain (e.g., may not delete) an entry in the coherence table CT that includes the coherence information 320 associated with the third transaction request TR3.

FIG. 1B is a block diagram depicting components of a memory device in the system of FIG. 1A, according to some embodiments of the present disclosure.

Referring to FIG. 1B, and as discussed above, the memory device MD may include a memory-device local memory LMA that is accessible for use in a memory pool. The memory device MD may include the access gateway AG and the local-memory manager LMM.

The access gateway AG may include: the local memory controller LMC, the remote prefetch manager RPM, the remote memory transaction controller RMTC, the map table MT with per-DMR performance attributes (also referred to as a memory proximity domain table (MPDT)), a coherence manager CM (including a coherence table CT), and a memory transaction packet dispatcher MPD (including a routing table RT, which is also referred to as a memory request/response routing table (MRRT)). The map table MT, the coherence table CT, and the routing table RT may separately and/or collectively be referred to as the data structure DS. For example, the data structure DS may refer to one or more data structures (e.g., tables) even if one or more of the data structures have different formats.

In some embodiments, the first port PA and the second port PB may be used for routing transaction requests TR and participation requests PR. The ports may transmit data packets DP to the memory transaction packet dispatcher MPD for routing to local or remote memory-device components. For example, the memory transaction packet dispatcher MPD may forward data packets DP to the local memory controller LMC for causing data operations (e.g., read operations or write operations) to be performed on the memory-device local memory LMA (e.g., the local memory controller LMC may perform the data operations). In other words, the local memory controller LMC may be the local memory controller for the memory-device local memory LMA. In some embodiments, the memory-device local memory LMA may include double-data rate (DDR) or low-power double data rate (LPDDR). The memory transaction packet dispatcher MPD may forward data packets DP to the remote memory transaction controller RMTC to redirect the data packets DP to remote memories. In some embodiments, the memory transaction packet dispatcher MPD may forward data packets DP to the stream processor SP for performing stream process operations.

In some embodiments, the memory transaction packet dispatcher MPD may transmit first control packets CPA to the coherence manager. For example, the memory transaction packet dispatcher MPD may collect information (e.g., coherence information, also referred to as coherence-control information) from the data packets DP and transmit the information to the coherence manager CM. For example, the coherence manager CM may make entries in the coherence table CT based on the information (e.g., the coherence-control information) collected from the data packets DP. In some embodiments, the coherence manager CM may determine whether to notify participating nodes regarding changes to data, based on coherence-control information in the coherence table CT. In some embodiments, the memory transaction packet dispatcher MPD may transmit second control packets CPB to the map table MT with per-DMR performance attributes. For example, the control packets CPB may have a different format from the first control packets CPA and may include performance-attribute-related information for entering into the map table MT. The map table MT may include information for determining whether resources of the memory device MD may meet performance attributes for a given memory pool (e.g., a given VPoM instance).

The local-memory manager LMM may include: the DMR resource manager RM, the DMR performance attribute training agent TA, and the VPoM instance information caching agent ICA. In some embodiments, the memory device MD may include a third port PC associated with an out-of-band channel (e.g., a management-only channel).

In some embodiments, the DMR Resource Manager RM creates/deletes/changes the partition of the local memory LM. The DMR resource manager RM may manage donation of the local memory partition to create the VPoM instance and may also manage withdrawal of the memory donated. When there are any changes regarding the DMR, DMR resource manager RM may notify the global manager GM so that the global manager GM can re-configure the related VPoM instances.

In some embodiments, the DMR performance attribute training agent TA may perform the test to evaluate the latency and throughput characteristics of remote memory (e.g., remote DMRs of the target VPoM instance). In some embodiments, DMR performance attribute training agent TA generates the memory access requests, and handles the responses to them, to evaluate the performance characteristics and also to evaluate the error rates and error modes. These remote memory access requests and responses may be transmitted over CXL interconnect. In some embodiments, each DMR performance attribute training agent TA may have its operation sequence coordinated by the global manager GM.

In some embodiments, VPoM instance information caching agent ICA manages the copy of information maintained by the global manager GM for quick access by the access gateway AG, such as current list of VPoM instances, memory transaction request routing table RT, per-DMR performance attributes, and/or the like. A VPoM information cache may allow for instance information to be communicated without the access gateway AG traveling across (e.g., transmitting requests across) the network to the global manager GM whenever the access gateway AG needs this information. In some embodiments, if any changes in a local DMR configuration or any faults occur in the local DMR, then the VPoM instance information caching agent ICA may inform the global manager GM about these events.

In some embodiments, the access gateway AG may include a special type of memory controller (e.g., remote memory transaction controller RMTC) to manage remote memory transactions. For efficient processing of memory transactions, the access gateway AG may handle the memory transactions separately based on the transaction types such as bulk memory transaction, atomic memory transaction, and normal memory transaction. Memory transaction type may be specified explicitly by the host H or may be classified automatically by the access gateway AG.

FIG. 2 is a block diagram depicting components of an access gateway of the memory device depicted in FIG. 1B, according to some embodiments of the present disclosure.

Referring to FIG. 2, and as discussed above, the access gateway AG may include the coherence manager CM and the memory transaction packet dispatcher MPD. The access gateway AG may monitor changes of specified memory areas and may inform relevant host CPUs regarding the changes so that the relevant CPUs (also referred to as hosts H) can invalidate the cache of the corresponding range of memory.

In some embodiments, the access gateway AG always knows if there are any data changes on its local DMR (e.g., the given shared memory SM that the given access gateway AG manages), based on utilizing a memory transaction monitor 212 in the memory transaction packet dispatcher MPD in the access gateway AG. Data chunks CNK (see FIG. 3B) associated with shared memories SM may be registered in the coherence table CT. When there are data changes in the memory chunks CNK registered in this coherence table CT, then the access gateway AG may check the current time and coherence information 320 (see FIG. 3A), including ‘Coherence::Data-Deadline’ information, so if the current time does not exceed the ‘Coherence::Data-Deadline’ time (e.g., the interest limit 322B depicted in FIG. 3A is not exceeded), then a data change notifier 224 sends data-change notifications DCN (e.g., data change notification messages) for the corresponding memory chunks CNK to the corresponding hosts H, so that the hosts H can invalidate the cache for the data retrieved (e.g., the data a given host is interested in). But if the current time already has passed the ‘Coherence::Data-Deadline’ time (e.g., the interest limit 322B depicted in FIG. 3A is exceeded), then the access gateway AG may delete the corresponding record in the table (e.g., in the coherence table CT), and may not send any data-change notification DCN. A table maintenance loop 222 (e.g., a coherence-management-table checker or a coherence-management-table-background checker) in the coherence manager CM may perform these actions based on the information provided by a per-memory-chunk runtime status bitmap 214 in the memory transaction packet dispatcher MPD. In some embodiments, the maintenance loop 222 may perform housekeeping check operations at a given frequency that may be determined based on a size of the coherence table CT and/or based on a speed of the housekeeping checking logic. For example, a larger coherence table CT may require more frequent housekeeping and/or a faster housekeeping checking logic may be able to be run more frequently. For example, a larger coherence table CT may utilize a faster logic (e.g., a faster table scan and/or a faster table-scan trigger logic (also referred to as scan&trigger logic)), or may utilize more logic (e.g., more scan&trigger logic) for a shared table, to satisfy a suitable coherence processing latency.

FIG. 3A is a block diagram depicting features of a memory transaction request packet for accessing data in a virtual pool-of-memory (VPoM) instance, the VPoM instance being created from donated memory regions (DMRs) of the system of FIG. 1A, according to some embodiments of the present disclosure.

Referring to FIG. 3A, any given transaction request TR may include a data packet DP. The data packet DP may may include a header HD and a data payload D. The header HD may include information for processing by the access gateway AG in performing its various functions and roles. For example, the header HD may include: source identifying information (e.g., source-port information 302), destination-port information 304, operation code information 306, data address information 308 (e.g., an offset), data length information 310, prefetch-related information 312, stream-processing-related information 314, and the coherence information 320 (e.g., coherence-control information) discussed above. The coherence information 320 may include a status 322 (e.g., information indicating a status of the coherence information 320).

For example, the status 322 may be represented by the opt-in status 322A (e.g., a first portion indicating a request to receive a data-change notification DCN for a given portion of data) and the interest limit 322B (e.g., a second portion representing a limit on the request to receive the data-change notification DCN for the given portion of data). In some embodiments, the opt-in status 322A may include (e.g., may be represented by) an option flag to get data-change notifications. For example, the option flag may include a bit that indicates an opt-out status in one setting (e.g., for the value of “0”) and that indicates an opt-in status in another setting (e.g., for the value of “1”). The interest limit 322B may include a time unit and a time value. For example, the time unit may be represented by one bit that indicates a first time unit in one setting (e.g., a unit of minutes for the value of “0”) and a second time unit in another setting (e.g., a unit of hours for the value of “1”). The time value may be represented by bits indicating the quantity of minutes or hours (e.g., or any other suitable unit). For example, six of the least significant bits (LSB) may be set to 000100 to represent a time value of 4 (e.g., 2\hat{ }2) or may be set to 001010 to represent a time value of 10 (e.g., 2\hat{ }3+2\hat{ }1). In some embodiments, the coherence information 320 may include 8 bits, with the most significant bit (MSB) representing the opt-in status 322A, the next most significant bit representing the time unit, and the six LSBs indicating the time value. For example, the eight bits 10000100 may indicate the opt-in status 322A of opted in and an interest limit of 4 minutes, the eight bits 10001010 may indicate the opt-in status 322A of opted in and an interest limit 322B of 10 minutes, and the eight bits 11000001 may indicate the opt-in status 322A of opted in and an interest limit 322B of 1 hour.

FIG. 3B is a diagram depicting coherence tables for coherence management for the VPoM instance created from DMRs of the system of FIG. 1A, according to some embodiments of the present disclosure.

Referring to FIG. 3B, each host H may include its own coherence table CT. For example, the first host H1 (see FIG. 1A) may include a first coherence table CT1, the second host H2 may include a second coherence table CT2, and the third host H3 may include a third coherence table CT3. Each coherence table CT may include three columns C (e.g., C1, C2, and C3) indicating information for whether a given memory chunk CNK is registered as being associated with a given host for data-change notifications DCN (e.g., provided by a data-change notification service of the coherence manager CM). The first column C1 may indicate chunk IDs, the second column C2 may indicate host IDs, and the third column C3 may indicate the coherence information 320 (e.g., including the option flag and a data deadline).

For example, the first coherence table CT1 may include a first row R1 indicating that the third host H3 has read some area of data in the memory chunk ID 2 of the first shared memory SM1 (e.g., DMR1) and noted that the data would be used for the next 4 minutes from the moment of data read (e.g., the third host 3 has indicated its interest in the data in the memory chunk ID 2 that will expire 4 minutes from the moment of data read). A second row R2 indicates that the second host H2 has read some area of data in the memory chunk ID 2 of the first shared memory SM1 (e.g., DMR1) and noted that the data would be used for the next 10 minutes from the moment of data read.

The second coherence table CT2 may include a first row R1 and a third row R3 indicating that the first host H1 has read some area of data in the memory chunk IDs 1 and 4 of the second shared memory SM2 (e.g., DMR2) and noted that the data would be used for the next 1 hour from the moment of data read. A second row R2 indicates that the second host H2 has read some area of data in the memory chunk ID 4 of the second shared memory SM2 (e.g., DMR2) and noted that the data would be used for the next 10 minutes from the moment of data read.

The third coherence table CT3 may include a first row R1, a second row R2, and a third row R3 indicating that the third host H3 has read some area of data in the memory chunk IDs 5, 6, and 7 of the third shared memory SM3 (e.g., DMR3) and noted that the data would be used for the next 5 minutes from the moment of data read. A fourth row R4 indicates that the first H1 has read some area of data in the memory chunk ID 1 of the third shared memory SM3 (e.g., DMR3) and noted that the data would be used for the next 1 hour from the moment of data read. A fifth row R5 indicates that the second H2 has read some area of data in the memory chunk ID 1 of the third shared memory SM3 (e.g., DMR3) and noted that the data would be used for the next 10 minutes from the moment of data read.

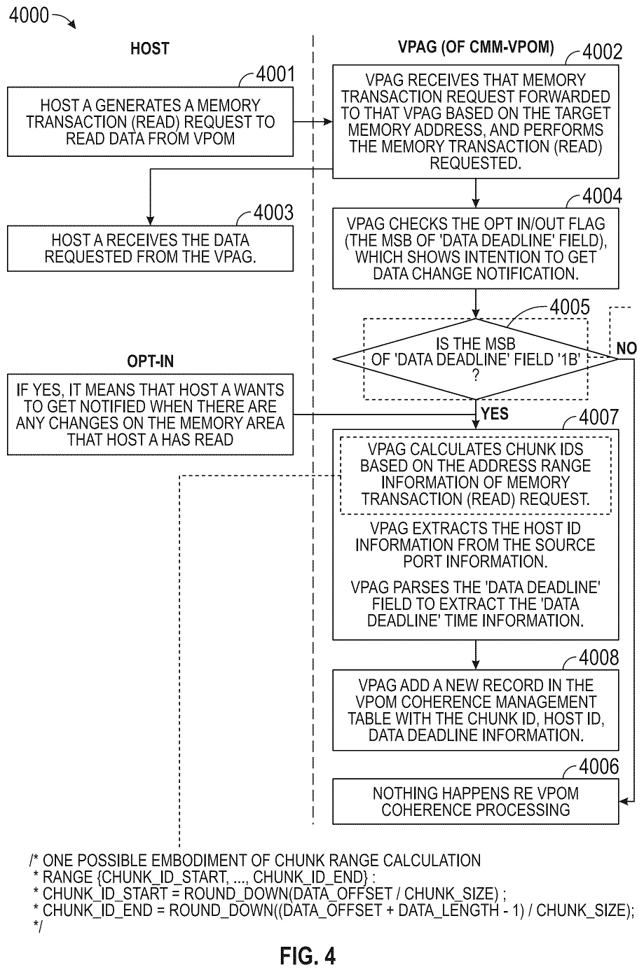

FIG. 4 is a diagram depicting a method 4000 for performing a VPoM coherence management operation when there is a VPoM memory read request, according to some embodiments of the present disclosure.

Referring to FIG. 4, the method 4000 may include one or more of the following operations. The second host H2 (e.g., Host A) may generate a transaction request TR (e.g., a memory transaction read request to read data from the VPoM) (operation 4001). The first access gateway AG1 of the first host H1 may receive the transaction request TR forwarded to the first access gateway AG1 based on a target memory address and may perform the memory transaction read requested (operation 4002). The second host H2 (e.g., Host A) may receive the data requested from the first access gateway AG1 (operation 4003). The first access gateway AG1 may check the opt-in/opt-out flag (e.g., the MSB of the data deadline field), which shows an intention (e.g., indicates a request or an interest) to get a data-change notification DCN (operation 4004). The first access gateway AG1 may determine whether the MSB of the data deadline field is set to “1” (indicating an opt-in status) (operation 4005). If the MSB of the data deadline field is not set to “1” (e.g., is set to “0”), nothing happens regarding VPoM coherence processing (operation 4006). If the MSB of the data deadline field is set to “1,” the first access gateway AG1 may determine that the second host H2 (e.g., Host A) wants to get notified when there are any changes on the memory area that Host A has read, and the first access gateway AG1 may: calculate chunk IDs based on the address range information of the transaction request TR, extract host ID information from the source-port information 302, and parse the data deadline field (e.g., the coherence information 320) to extract the data deadline time information (e.g., the interest limit 322B) (operation 4007). The first access gateway AG1 may add a new record in the coherence table CT with the chunk ID, the host ID, and the data deadline information (e.g., with the coherence information 320) (operation 4008).

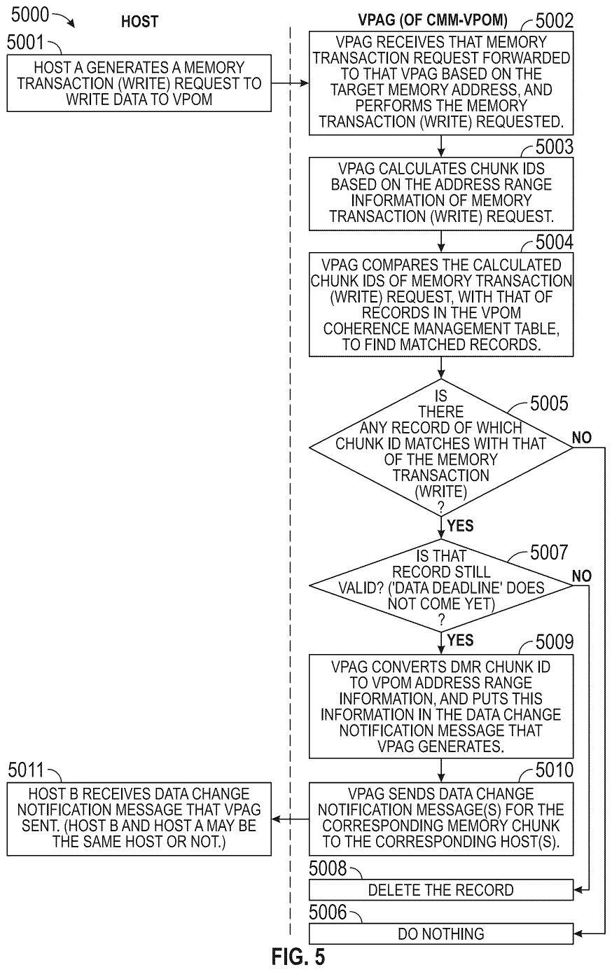

FIG. 5 is a diagram depicting a method 5000 for performing a VPoM coherence management operation when there is a VPoM memory write request, according to some embodiments of the present disclosure.

Referring to FIG. 5, the method 5000 may include one or more of the following operations. The second host H2 (e.g., Host A) may generate a transaction request TR (e.g., a memory transaction write request to write data to the VPoM) (operation 5001). The first access gateway AG1 of the first host H1 may receive the transaction request TR forwarded to the first access gateway AG1 based on a target memory address and may perform the memory transaction write requested (operation 5002). The first access gateway AG1 may calculate chunk IDs based on the address range information of the transaction request TR (operation 5003). The first access gateway AG1 may compare the calculated chunk IDs of the transaction request TR with that of records in the coherence table CT to find matching records (operation 5004). The first access gateway AG1 may determine whether there are any records having chunk IDs that match with chunk IDs of the transaction request TR (operation 5005). If there are no matches, then nothing happens further with coherence management processing for that transaction request TR (operation 5006). If there are matches, then the first access gateway AG1 may determine whether the records having matches are still valid (e.g., have a data deadline that has not expired) (operation 5007). If there are no valid records remaining for that transaction request TR, the first access gateway AG1 may delete the records that are no longer valid (operation 5008). If there are valid records remaining for that transaction request TR, then the first access gateway AG1 may convert DMR chunk IDs to VPoM address range information and may put this information in a data-change notification message generated by the first access gateway AG1 (operation 5009). The first access gateway AG1 may send data-change notifications DCN (e.g., data-change notification messages), for corresponding memory chunks, to the corresponding hosts H (operation 5010). The second host H2 (e.g., Host A) or the third host H3 (e.g., Host B) may receive one or more of the data-change notifications DCN (operation 5011).

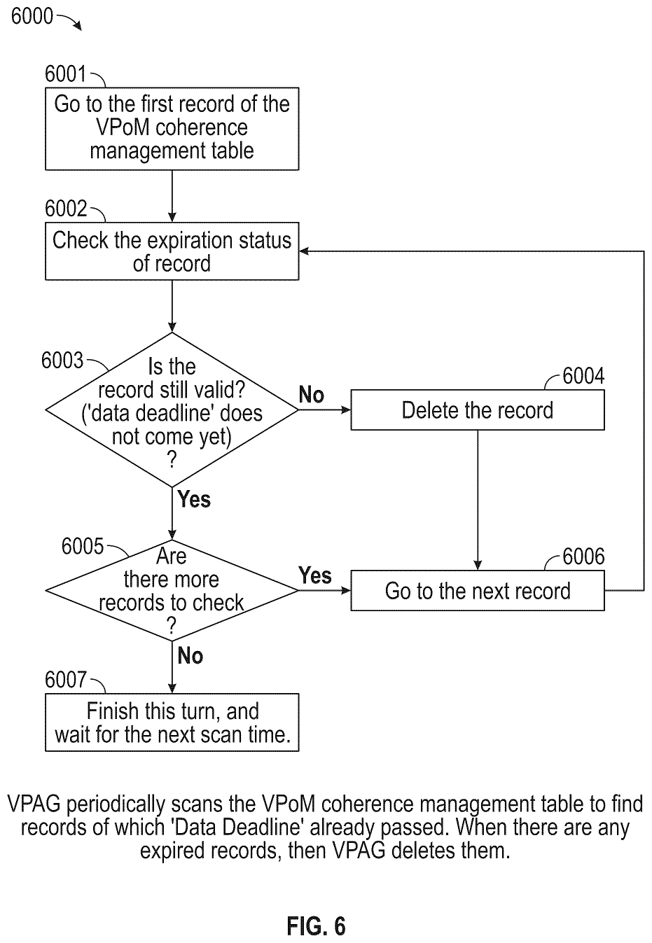

FIG. 6 is a diagram depicting a method 6000 for performing a VPoM coherence management operation for implementing a periodic housekeeping task loop, according to some embodiments of the present disclosure.

Referring to FIG. 6, the method 6000 may include one or more of the following operations. In some embodiments, to perform periodic housekeeping of records (e.g., entries) in the coherence table CT, when housekeeping operations are enabled, the access gateway AG may search (e.g., may scan) the coherence table CT for entries having a limit that has been exceeded (e.g., having a second status) and may modify (e.g., clear and/or make available for entries associated with other transaction requests) entries in the coherence table CT. For example, the access gateway AG may go to the first record of the coherence table CT (operation 6001). The access gateway AG may check the expiration status of the record (operation 6002). The access gateway AG may determine whether the record is still valid (e.g., whether the data deadline has not yet expired) (operation 6003). If the record is not valid (e.g., if the data deadline has expired (or occurred)), the access gateway AG may delete the record from the coherence table CT (operation 6004) and may go to the next record in the coherence table CT (operation 6006). If the record is valid (e.g., if the data deadline has not expired), the access gateway AG may determine whether there are more records to check (operation 6005). If there are more records to check, the access gateway AG may go to the next record (operation 6006). If there are no more records to check, the access gateway AG may finish its turn and wait for the next scan time (e.g., the next periodically scheduled scan time) (operation 6007).

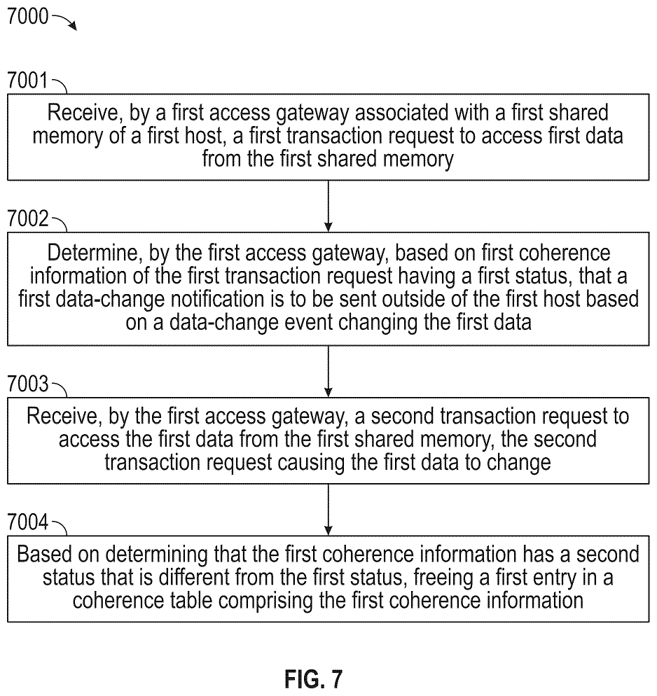

FIG. 7 is a diagram depicting a method 7000 for memory management for a VPoM, according to some embodiments of the present disclosure.

Referring to FIG. 7, the method 7000 may include one or more of the following operations. A first access gateway AG (e.g., AG1) associated with a first shared memory SM (e.g., SM1) of a first host H (see, e.g., the first host H1 depicted in FIGS. 1A, 1B, and 2) may receive a first transaction request TR1 to access first data from the first shared memory SM1 (operation 7001). The first transaction request TR1 (e.g., a read request or a write request) may include coherence information 320 (see, e.g., FIG. 3A) having a first status 322 (e.g., an opt-in status 322A indicating opted in and an interest limit 322B indicating interested). The first status 322 may indicate that a source of the first transaction request TR1 (e.g., the second host H2) has requested to receive data-change notifications DCN (see, e.g., FIG. 2) if a data-change event changes the first data and if the second host H2 is still interested (e.g., if a data-deadline time indicated by the second host H2 has not expired). In other words, the status 322 of the coherence information 320 may indicate that a data-change notification is to be sent outside of the first host H1 based on (e.g., in the event of) a data-change event changing the first data.

In some embodiments, the first access gateway AG1 may determine that a data-change notification DCN is to be sent (e.g., has been requested to be sent) outside of the first host H1 (e.g., to the second host H2) in the event that a data-change event occurs in the first data (operation 7002). In some embodiments, the first access gateway AG1 may determine that a data-change event occurs and that a data-change notification DCN is to be sent (e.g., has been requested to be sent) outside of the first host H1 (e.g., to the second host H2) in the event that a data-change event occurs in the first data. In some embodiments, the first access gateway AG1 may determine that a data-change event occurs and that a data-change notification DCN is to be sent (e.g., has been requested to be sent) outside of the first host H1 (e.g., to the second host H2) in the event that a data-change event occurs in the first data (e.g., based on the data event occurring in the first data).

The first access gateway AG1 may receive a second transaction request TR2 to access the first data from the first shared memory SM1. For example, the third host H3 may be the source of the second transaction request TR2. The first data may change as a result of the second transaction request TR2 (e.g., a data-change event may occur in the first data due to a data operation associated with the second transaction request TR2 being performed on the first data) (operation 7003). The first access gateway AG1 may scan a coherence table CT (e.g., a coherence-control table), based on the data-change event occurring in the first data, to determine if the first status 322 indicates that the second host H2 is still interested in receiving data-change notifications DCN regarding the first data. For example, the first access gateway AG1 may determine whether the interest limit 322B indicates that a data deadline has expired (e.g., by comparing the data deadline with a period of time that has passed since the first transaction request TR1 was received). The first access gateway AG1 may determine that the coherence information 320 has a second status 322 (e.g., an opt-in status 322A indicating opted in and an interest limit 322B indicating not interested (no longer interested or expired)). Based on the second status 322 indicating not interested, the first access gateway AG1 may determine not to send the data-change notification DCN, even though a data-change event has occurred in the first data (operation 7004). Additionally, the first access gateway AG1 may modify (e.g., clear or delete) an entry in the coherence table CT that included the coherence information 320 associated with the first transaction request (operation 7004), to save memory in the coherence table CT. That is, the first access gateway AG1 may make a memory space (e.g., a portion of the first local memory LM1 corresponding to the entry in the coherence table CT), including data associated with a request to receive the data-change notification DCN, available. For example, the portion of the first local memory LM1 may be made available for entries related to other transaction requests.

If, after the data-change event had occurred in the first data, the status 322 was still the first status (e.g., an opt-in status 322A indicating opted in and an interest limit 322B indicating interested), then the first access gateway AG1 would send the data-change notification DCN to the second host H2. Accordingly, overhead and signaling involved with managing data coherence may be reduced, when compared to other approaches where data-change notifications would be sent to multiple hosts for data changes even when there was never any interest and/or when there is no longer any interest in receiving the data-change notifications.

Accordingly, aspects of some embodiments of the present disclosure may provide improvements to managing memory for a pool of memory by utilizing an interest-based coherence management scheme for providing more consistent memory bandwidth and lower latency compared to other approaches, such as approaches using centralized and physical memory pools (e.g., physical CXL memory pools).

Example embodiments of the disclosure may extend to the following statements, without limitation:

Statement 1. An example method includes receiving, by an access processing circuit associated with a first shared memory of a first host, a first transaction request, the first transaction request including a request to access first data from the first shared memory, and including first coherence information having a first status, the first coherence information indicating a request to receive a first data-change notification, receiving, by the access processing circuit, a second transaction request to access the first data from the first shared memory, the second transaction request causing a first data change of the first data, and based on determining that the first coherence information has a second status that is different from the first status, modifying a first entry including the first coherence information.

Statement 2. An example method includes the method of statement 1, and further includes receiving, by the access processing circuit, a third transaction request causing a second data change of second data of the first shared memory, and based on determining that second coherence information has the first status, sending a second data-change notification.

Statement 3. An example method includes the method of any of statements 1 and 2, wherein the modifying the first entry includes making a memory space, including data associated with the request to receive the first data-change notification, available.

Statement 4. An example method includes the method of any of statements 1-3, wherein the first coherence information includes a first portion indicating the request to receive the first data-change notification and a second portion representing a limit on the request to receive the first data-change notification, and the second status indicates that the limit is exceeded.

Statement 5. An example method includes the method of any of statements 1-4, wherein the first transaction request includes a header, the header including the first coherence information and source identifying information, the source identifying information indicating the source of the first transaction request.

Statement 6. An example method includes the method of any of statements 1-5, wherein the access processing circuit determines that the first data-change notification is to be sent outside of the first host based on the first coherence information, and the method further includes adding the first entry, the first entry including the first coherence information.

Statement 7. An example method includes the method of any of statements 1-6, and further includes searching, by the access processing circuit, a coherence table for a second entry having the second status, and modifying the second entry in the coherence table.

Statement 8. An example system for performing the method of any of statements 1-7 includes a processing circuit, and a memory storing instructions, which, based on being executed by the processing circuit, cause the processing circuit to perform the method of any of statements 1-7.

While embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A method for memory management, the method comprising:
receiving, by an access processing circuit associated with a first shared memory of a first host, a first transaction request, the first transaction request comprising a request to access first data from the first shared memory, and comprising first coherence information having a first status, the first coherence information indicating a request to receive a first data-change notification,
receiving, by the access processing circuit, a second transaction request to access the first data from the first shared memory, the second transaction request causing a first data change of the first data, and
based on determining that the first coherence information has a second status that is different from the first status, modifying a first entry comprising the first coherence information.

2. The method of claim 1, further comprising:
receiving, by the access processing circuit, a third transaction request causing a second data change of second data of the first shared memory, and
based on determining that second coherence information has the first status, sending a second data-change notification.

3. The method of claim 1, wherein the modifying the first entry comprises making a memory space, comprising data associated with the request to receive the first data-change notification, available.

4. The method of claim 1, wherein:
the first coherence information comprises a first portion indicating the request to receive the first data-change notification and a second portion representing a limit on the request to receive the first data-change notification, and
the second status indicates that the limit is exceeded.

5. The method of claim 1, wherein the first transaction request comprises a header, the header comprising the first coherence information and source identifying information, the source identifying information indicating the source of the first transaction request.

6. The method of claim 1, wherein:
the access processing circuit determines that the first data-change notification is to be sent outside of the first host based on the first coherence information, and
the method further comprises adding the first entry, the first entry comprising the first coherence information.

7. The method of claim 1, further comprising:
searching, by the access processing circuit, a coherence table for a second entry having the second status, and
modifying the second entry in the coherence table.

8. A system comprising:
a processing circuit, and
a memory storing instructions, which, based on being executed by the processing circuit, cause the processing circuit to perform:
receiving a first transaction request comprising a request to access first data from a first shared memory, and comprising first coherence information having a first status, the first coherence information indicating a request to receive a first data-change notification,
receiving a second transaction request to access the first data from the first shared memory, the second transaction request causing a first data change of the first data, and
based on determining that the first coherence information has a second status that is different from the first status, modifying a first entry comprising the first coherence information.

9. The system of claim 8, wherein the instructions, based on being executed by the processing circuit, cause the processing circuit to perform:
receiving a third transaction request causing a second data change of second data of the first shared memory, and
based on determining that second coherence information has the first status, sending a second data-change notification.

10. The system of claim 8, wherein the modifying the first entry comprises making a memory space, comprising data associated with the request to receive the first data-change notification, available.

11. The system of claim 8, wherein:
the first coherence information comprises a first portion indicating the request to receive the first data-change notification and a second portion representing a limit on the request to receive the first data-change notification, and
the second status indicates that the limit is exceeded.

12. The system of claim 8, wherein the first transaction request comprises a header, the header comprising the first coherence information and source identifying information, the source identifying information indicating the source of the first transaction request.

13. The system of claim 8, wherein the instructions, based on being executed by the processing circuit, cause the processing circuit to perform:
determining that the first data-change notification is to be sent outside of the first host based on the first coherence information, and
adding the first entry, the first entry comprising the first coherence information.

14. The system of claim 8, wherein the instructions, based on being executed by the processing circuit, cause the processing circuit to perform:
searching a coherence table for a second entry having the second status, and
modifying the second entry in the coherence table.

15. A system comprising:
an access processing circuit associated with a first shared memory, wherein the access processing circuit is configured to perform:
receiving a first transaction request comprising a request to access first data from the first shared memory, and comprising first coherence information having a first status, the first coherence information indicating a request to receive a first data-change notification,
receiving a second transaction request to access the first data from the first shared memory, the second transaction request causing a first data change of the first data, and
based on determining that the first coherence information has a second status that is different from the first status, modifying a first entry comprising the first coherence information.

16. The system of claim 15, wherein the access processing circuit is configured to perform:
receiving a third transaction request causing a second data change of second data of the first shared memory, and
based on determining that second coherence information has the first status, sending a second data-change notification.

17. The system of claim 15, wherein the modifying the first entry comprises making a memory space, comprising data associated with the request to receive the first data-change notification, available.

18. The system of claim 15, wherein:
the first coherence information comprises a first portion indicating the request to receive the first data-change notification and a second portion representing a limit on the request to receive the first data-change notification, and
the second status indicates that the limit is exceeded.

19. The system of claim 15, wherein the first transaction request comprises a header, the header comprising the first coherence information and source identifying information, the source identifying information indicating a source of the first transaction request.

20. The system of claim 15, wherein the access processing circuit is configured to perform:
searching a coherence table for a second entry having the second status, and
modifying the second entry in the coherence table.
